(19) United States
(12) Patent Application Publication
(10) Pub. No.: US 2017/0255935 A1
(43) Pub. Date: Sep. 7, 2017

(54) Policy-Based Control of Online Financial Transactions

(71) Applicant: Sequitur Labs, Inc., Issaquah, WA (US)

(72) Inventor: Philip Attfield, Fall City, WA (US)

(21) Appl. No.: 15/517,481

(22) PCT Filed: Oct. 8, 2015
(86) PCT No.: PCT/US15/54686

§ 371 Date: Apr. 6, 2017

Related U.S. Application Data
(60) Provisional application No. 62/062,568, filed on Oct. 10, 2014.

(51) Int. Cl. G06Q 20/40; G06Q 40/02; G06F 21/51; G06Q 20/04; G06Q 30/06

(52) U.S. Cl. CPC G06Q 20/405; G06Q 20/04; G06Q 30/06; G06F 21/51; G06Q 40/02

(57) ABSTRACT

A policy-based control system for on-line financial transactions where transaction requests and associated contextual information is used by a policy-based transaction server to evaluate the allowance or disallowance of a requested transaction. The system is connected to one or more fund resources. A fund usage request, initiated by the requestor, is received by the policy-based transaction server where a set of policy rules that govern the allowance of all transactions associated with that fund resource are used to adjudicate the request. The resulting adjudicated response is transmitted back to the requestor where it is enforced, either allowing the transaction or disallowing the transaction. The policy-based transaction server may use contextual information about the fund usage request to determine allowance.

### CROSS-REFERENCE TO RELATED APPLICATIONS

This application is entitled to the benefit of, and claims priority to U.S. Provisional Application 62/062,568, filed on Oct. 10, 2014.

### TECHNICAL FIELD

The present invention relates to the technical fields of Computer Security, Mobile Computing, Telecommunications, Digital Communications, Computer Technology, and Electronic Commerce.

### BACKGROUND OF THE INVENTION

The use of money as a medium of exchange for payments for goods and services, for payment of debts, and for other transfers of value, dates back many centuries. More recently, after the advent of the internet, online payment services and systems such as PayPal (http://paypal.com), Google Wallet (https://wallet.google.com), Apple Pay (https://www.apple.com/iphone-6/apple-pay/), plus secure online banking capabilities are now offered by many banks. Also very recently, Bitcoin (https:/bitcoin.org), a cryptographically-based currency, has been proposed that provides for payment of transactions between parties based on cryptographic proof. Furthermore, commonly used systems such as credit card and debit card systems are employing new electronic technologies and other technologies utilizing network capabilities for controlling and monitoring transactions. The demand for all forms of internet-enabled commerce is on the rise.

Money is a general purpose exchange medium. However, certain crediting, discounting, payment, and reimbursement systems related to purchase transactions may have requirements and limitations with regard to permissible spending. For example, discount coupons are typically only applicable to specific products and vendors. Also, customer loyalty and rewards programs may have internal currencies such as “air miles” for which purchasing options are limited in various ways. Welfare programs and other government services may provide funds for specific purposes. A related example is food stamps, which have a very specific intent regarding what products they can be exchanged for.

Major credit card providers (e.g. Visa, Mastercard) have corporate programs for employees that have conditional rules associated with them. An employer can participate in these programs whereby employees receive a corporate credit card tied to a corporate account and the card may have rules associated with it (related to travel expenses, for example). However, these programs are tied to only one line of accounting and the rules that govern the allowance or rejection of a specific purchase request are predetermined and are not dynamic nor are they identified by a descriptive rule set that can be customized by the customer.

The administrators, managers, and users of such monetary and payment systems may have specific intended purposes for funds, as well as regulatory requirements that must be met. Therefore, there exists a demand for comprehensive, dynamic, rule-based management of modern financial entities that constitute or represent “money”, and for related network-supported transaction and payment systems, to prevent spending of funds for purposes other than the intended or otherwise allowed ones, and to prevent malicious, fraudulent, or otherwise criminal use and theft of the funds.

### SUMMARY OF THE INVENTION

Disclosed herein is an invention for the control of financial transactions based on pre-defined policies. The invention is based in part on a pending patent application that describes a system and methods for managing policy-based rules for access to computing and peripheral resources The same concept is extended here to include policies for financial transactions. The system of the present invention allows for the authoring of policy rules for when and where transactions are to be approved or rejected. The rules can consider time, place, amount, purchase type, or any other restriction imagined. The system includes direct connection to funds accounts from which approved transactions will be charged against.

### BRIEF DESCRIPTION OF THE DRAWINGS

FIG. 1. Schematic representation of basic system

FIG. 2. Flowchart of example candidate transaction handling sequence

### DESCRIPTION OF THE INVENTION

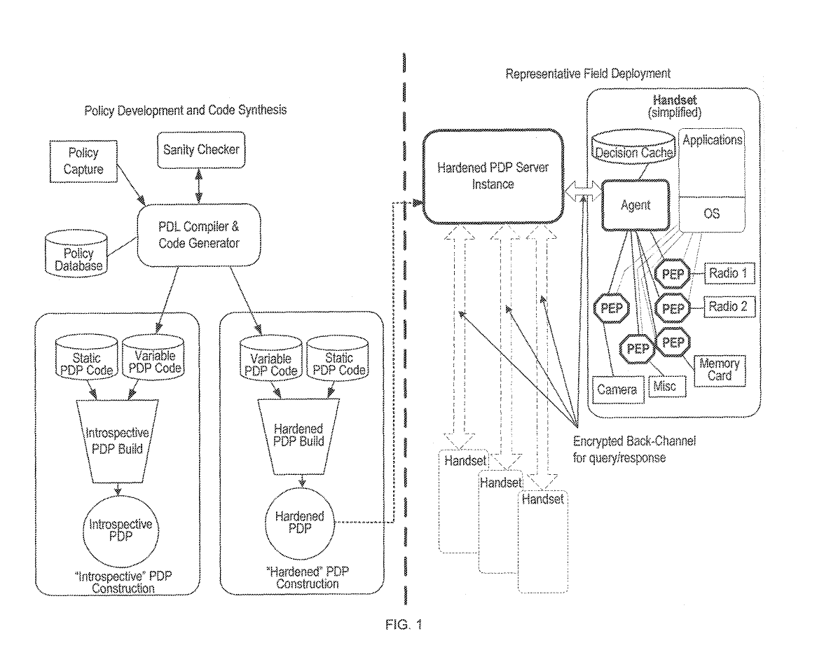

U.S. patent application Ser. No. 13/945,677, incorporated herein by reference, discloses a system for policy-based access control and management for mobile computing devices. The basic system presented in that application is depicted in FIG. 1. The system described therein provides extensive granularity of control over permitted operations, plus network, file system, and device access on devices controlled by the system. Furthermore, the system utilizes one or more policy decision point (PDP) servers which respond to encrypted queries from computing devices controlled by a given instance of the system. These PDP servers may be remote from the computing device, or may even be hosted within the computing device. The queries typically encapsulate requests for use of specific device or network-accessible assets. The PDP response to such a request is then received by the querying device, with subsequent decisions made by the PDP then enforced at the Policy Enforcement Points (PEPS) on the device.

As noted in U.S. patent application Ser. No. 13/945,677, the system utilizes a unique policy object language (POW for expressing policies and policy sets, and employs a specialized policy processor that synthesizes and outputs source code for later use in building PDP servers. A “policy” consists of rules and restrictions governing how a certain computing device capability, onboard device, or onboard information, or network-accessible information, or any other asset or resource that the computing device might be able to access, control or otherwise utilize, may be accessed and used by the computing device user or by other entities. A “policy set” is a collection of policies and associated information, including policy ownership information. Here, a “policy-owner” is the person or entity having responsibility for the policies in a particular policy set. Each ‘policy-owner’ establishes policies to cover security concerns for some entity. As non-limiting examples, such an entity might be a wireless carrier or other network service provider, or a provider of a service available over a network, or a device manufacturer, or a corporate device owner, or an end user of the device. In some cases, the policy-owner and that entity might be identical.

The system and method of the present invention employs a policy-based control and management system that is used to comprehensively manage the allocation, spending, and movement of funds, before and throughout transactions, thereby providing a powerful, hierarchical transaction control system.

First, each funds bundle or funds amount to be governed within the system is assigned to one or more policy sets. The funds bundle may be an amount of money allocated, for example, in a budget or grant. It may be an account balance or other sum of money made available as a source for funding one or more candidate transactions. It is a line of accounting that is made available to the user under a specific set of conditions (the “policy set”). The assignment may be accomplished through a lookup table, a database entry, or by other means. A unique funds bundle identifier may be applied. Such an identifier may incorporate or otherwise utilize a timestamp, Additionally, metadata may be assigned to the candidate transaction that may provide contextual information or other information that can be used in determining applicability of specific policies. When multiple transactions to a common recipient are applied to the same funds source, allowed transactions may be performed individually or as one aggregated transaction. This may be desired to reduce transaction fees, for example.

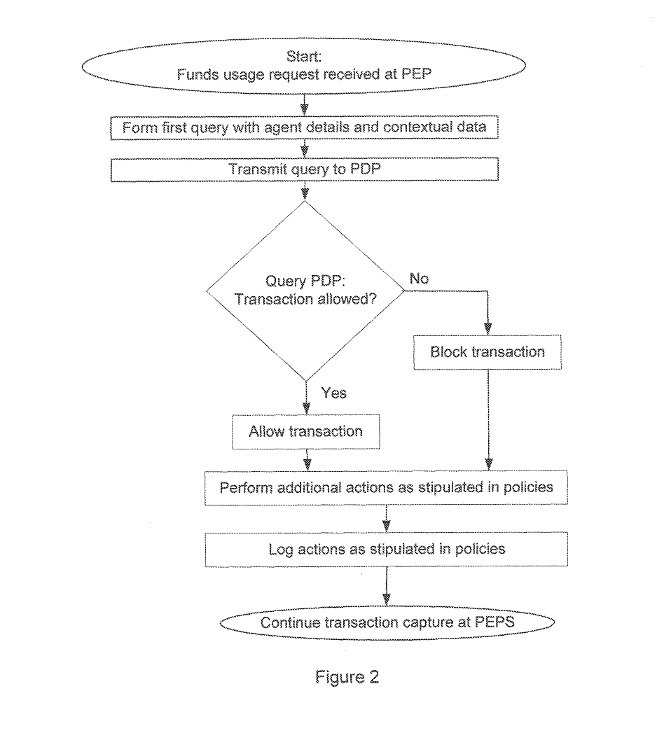

Processing of any candidate transaction using all or a portion of the funds bundle results in a funds usage request that is intercepted by a PEP. The PEP then issues a query to a PDP in the system that includes the details of the funds bundle and the candidate transaction such that applicable policies can be selected and evaluated. The evaluation will result in an Allow or Deny verdict for the candidate transaction. In addition, stipulations of other actions such as transaction logging or notification of specific parties such as financial governance authorities or other authorities may be performed as specified by policy. A blocked transaction may include an option to switch to a different funds bundle with a different rule set. For example, if a transaction is denied on a corporate account, a personal account may be substituted. This process is presented in FIG. 2.

A policy-based system, according to the present invention, has an unbounded set of potential rules for restricting and specifying use of funds that can be expressed in policies. The invention includes, but is not limited to, the following rules and variants, which may be used in any combination:
Purchases must be from specified or qualified vendor(s)
Purchased product(s) must be in allowed categories or of specified product type or product model
Purchased products must have specified Universal Product Codes (UPCs) or other product-identifiers or product category identifiers codes
Purchase must be made in a specific country or regional jurisdiction
Purchase must be made within a specific date range, or before or after specific dates, or within a specified time interval after an activation step.
Purchase must be approved by one or more specified parties
Purchase must be established to be utilized for a specified purpose, prior to release of funds for payment

Notably, the present invention has direct applications in controlling transactions associated with many business activities, and in accounting for these activities. Beyond rules such as those listed above, the system may also utilize specific accounting standards, such as Generally Accepted Accounting Principles (GAAP) as referenced here http://www.fasab.gov/accounting-standards/authoritative-source-of-gaap/, as sources of rules to be applied in policies governing transactions, and also as a standard for transaction logging. Furthermore, With regard to accounting, logging activities such as those shown in the flowchart of FIG. 2 may include, or may consist of, direct or subsequent entry of transactions into an accounting system.

In one use case of the invention focused at the point of sale, an employee is on an official business trip for her employer. She will use an eWallet system. on her smart phone such as Google Wallet or Apple Pay for all of her transactions. The invention will be used to authorize her purchases. She is authorized for travel-related expenses such as meals, taxis, and hotel, but not for entertainment expenses such as movies. She goes to dinner and pays with her eWallet. The purchase passes through the PDP which approves the transaction because meals are allowed. She later goes to a movie. Here, the transaction is denied because the PDP blocks it based on the “no entertainment” rule. When she returns from her trip, an accounting of approved transactions is made for her. She needs no reimbursement because all valid transactions were paid directly by her approved line of accounting.

In another use case of the invention focused after sale, an employee has completed a business trip for his employer and wishes to be reimbursed for travel-related expenses incurred during the trip. Allowable expenses according to corporate policies include transportation and meal costs, but do not include entertainment. The employee submits a set of expense records such as expense receipts, in some form that they can be entered or otherwise ingested into an instance of the system so that candidate reimbursement transactions can be formed or otherwise represented. Included in the employee's submitted expenses are $400 for airfare, $50 for taxi fare, $100 for meals, and $35 for a movie viewing expense. This results in four distinct candidate reimbursements. The first three airfare, taxi, and meals expenses) receive an “Allow” result in the system, and the final expense, being entertainment, receives a “Block” result denying the requested transaction. The end result is expense reimbursement from the company to the employee totaling $550.00. This may come in the form of one single aggregated transaction or as individual. transactions.

### INDUSTRIAL APPLICATION

The invention applies generally to any industry requiring detailed accounting services and control for authorized expenditures.

What is claimed is:

1. A system for secure online financial transactions comprising:
a funding interface connected to one or more fund resources including a lookup table, a database reference, or an explicit financial account number;
a policy-based transaction server having a set of policy rules that govern the allowance of a fiords usage request for adjudicating the funds usage request using the set of policy rules, and for approving or not approving the funds usage request based on the outcome of the policy-based server adjudication;
a request interface, coupled to the policy-based transaction server, for receiving a fund usage request from a requestor requesting permission to execute a financial transaction, and for transmitting the fund usage request to the policy-based. transaction server for adjudication; and
a response interface, coupled to the funding interface, for transmitting the adjudicated request response to the requestor and to the funding interface if the fund usage request is approved.

2. The system of claim 1, wherein the policy-based transaction server executes additional or alternate actions after adjudication of the fund usage request and subsequent delivery of the response as stipulated in the set of policy rules.

3. The system of claim 1, wherein the fund usage request contains metadata describing the attributes of the request including the amount, the purpose, the time and date, and other contextual descriptors.

4. The system of claim 1, wherein the policy-based transaction server is configured to capture and log approved and rejected fund usage requests.

5. The system of claim 1, wherein multiple fund access requests are aggregated if they pertain to a common recipient or vendor and are applied to the same fund resource.

6. A method for secure online financial transactions comprising the steps of:
connecting to one or more fund resources including a lookup table, a database reference, or an explicit financial account number;
initiating a fund usage request for permission to execute a financial transaction;
evaluating a set of policy rules that determine if the fund usage request is allowable or is not allowable;
responding to the fund usage request based on the outcome of the policy rules evaluation.

7. The method of claim 6, further including the step of executing additional or alternate actions following the evaluation of the set of policy rules.

8. The method of claim 6 wherein the fund usage request contains metadata describing the attributes of the request that may include, but is not limited to the amount, the purpose, the time and date, and other contextual descriptors.

9. The method of claim 6, further including the step of capturing and storing responses to fund usage requests in a data repository.

10. The method of claim 6, further including the step of aggregating multiple fund access requests if they pertain to a common recipient or vendor and are applied to the same fund resource.
